(19) United States
(12) Patent Application Publication
(10) Pub. No.: US 2012/0078833 A1
(43) Pub. Date: Mar. 29, 2012

(54) BUSINESS RULES FOR RECOMMENDING ADDITIONAL CAMERA PLACEMENT

(75) Inventor: Jeffrey R. Johnson, Herndon, VA (US)

(73) Assignee: Unisys Corp., Blue Bell, PA (US)

(21) Appl. No.: 12/940,184

(22) Filed: Nov. 5, 2010

Related U.S. Application Data
(60) Provisional application No. 61/387,618, filed on Sep. 29, 2010.

(51) Int. Cl. G06N 5/02

(52) U.S. Cl. 706/47

(57) ABSTRACT

Business rules may be defined for camera placement in a video surveillance system, such as a system monitoring an airport. The business rules may be logical rules having an if-then format. For example, the if portion of the business rule may include a category, a surveillance area, and a business case for a proposed location. The then portion of the business rule may specify a recommendation to install an additional security camera in the video surveillance system at the proposed location. The recommendation may be calculated using a spreadsheet. The business rules provide justification for recommending a new camera placement and provide sound reasoning to assist in decision making when considering new camera locations in a video surveillance system.

### TECHNICAL FIELD

The instant disclosure relates to business rules. More specifically, the disclosure relates to an application for determining placement of additional cameras.

### BACKGROUND

Designing video surveillance systems involves several parties, each a stakeholder in the video surveillance system. Each stakeholder may have different perspectives on the needs of the video surveillance system. For example, law enforcement officers may desire an abundance of cameras in the video surveillance system, whereas budget managers may have a difficult time justifying the expense for an abundance of cameras in the video surveillance system. Thus, there is a need for a systematic process of determining where to place cameras in a video surveillance system.

### SUMMARY

According to one embodiment, a method includes receiving a category for a rule. The method also includes receiving a surveillance area for the rule. The method further includes receiving a business case for the rule. The method also includes recommending an outcome for the rule when conditions involving the category, the surveillance area, and the business case are met.

According to another embodiment, an apparatus includes a processor and a memory coupled to the processor, in which the processor is configured to receive a category for a rule. The processor is also configured to receive a surveillance area for the rule. The processor is further configured to receive a business case for the rule. The processor is also configured to recommend an outcome for the rule when conditions involving the category, the surveillance area, and the business case are met.

According to yet another embodiment, a computer program product includes a computer-readable medium having code to receive a category for a rule. The medium also includes code to receive a surveillance area for the rule. The medium further includes code to receive a business case for the rule. The medium also includes code to recommend an outcome for the rule when conditions involving the category, the surveillance area, and the business case are met.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an information system according to one embodiment of the disclosure.

FIG. 2 is block diagram illustrating a data management system configured to store business rules according to one embodiment of the disclosure.

FIG. 3 is a block diagram illustrating a server according to one embodiment of the disclosure.

FIG. 4 is a flow chart illustrating a method of determining placement of a camera in a video surveillance system according to one embodiment of the disclosure.

FIG. 5 is a example screen shot of a spreadsheet for recommending additional locations for security cameras according to one embodiment.

### DETAILED DESCRIPTION

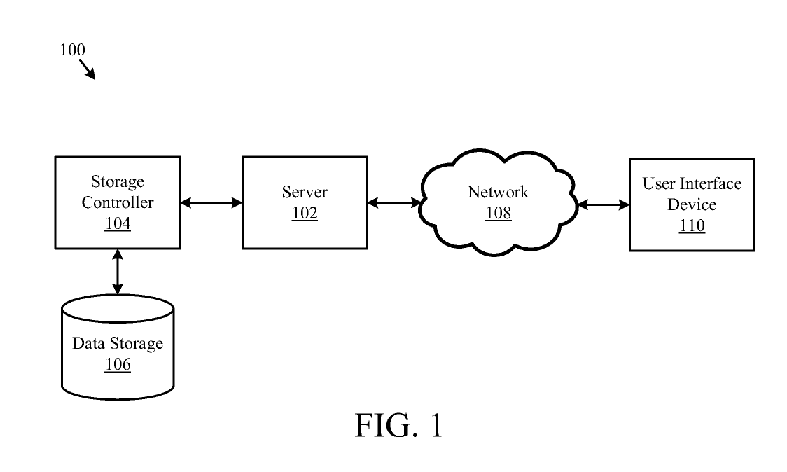

FIG. 1 illustrates one embodiment of a system 100 for an information system. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA) or table computer, a smartphone or other a mobile communication device or organizer device having access to the network 108. In a further embodiment, the user interface device 110 may access the Internet or other wide area or local area network to access a web application or web service hosted by the server 102 and provide a user interface for enabling a user to enter or receive information.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the server 102 is configured to store business rules and calculate recommendations based on the business rules. Additionally, spreadsheets for calculating recommendations on the server 102 may access data stored in the data storage device 106 via a Storage Area Network (SAN) connection, a LAN, a data bus, or the like. The data storage device 106 may include a hard disk, including hard disks arranged in an Redundant Array of Independent Disks (RAID) array, a tape storage drive comprising a magnetic tape data storage device, an optical storage device, or the like. The data may be arranged in a database and accessible through Structured Query Language (SQL) queries, or other data base query languages or operations.

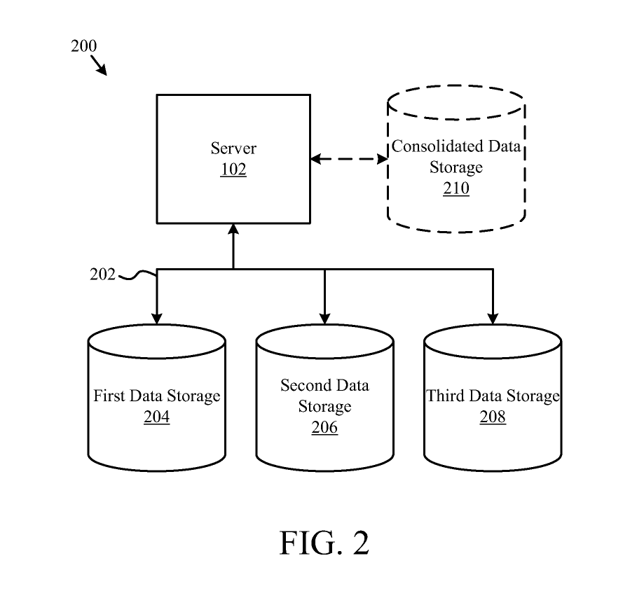

FIG. 2 illustrates one embodiment of a data management system 200 configured to provide data access for session beans. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In such an embodiment, each data storage device 204, 206, 208 may each host a separate database that may, in conjunction with the other databases, contain redundant data. Alternatively, the storage devices 204, 206, 208 may be arranged in a RAID configuration for storing a database or databases through may contain redundant data.

In one embodiment, the server 102 may submit a query to selected data from the storage devices 204, 206. The server 102 may store consolidated data sets in a consolidated data storage device 210. In such an embodiment, the server 102 may refer back to the consolidated data storage device 210 to obtain a set of data elements for a business rule at the request of a spreadsheet. Alternatively, the server 102 may query each of the data storage devices 204, 206, 208 independently or in a distributed query to obtain the set of data elements. In another alternative embodiment, multiple databases may be stored on a single consolidated data storage device 210.

In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 102 may communicate indirectly with the data storage devices 204, 206, 208, 210; the server 102 first communicating with a storage server or the storage controller 104.

The server 102 may include modules for interfacing with the data storage devices 204, 206, 208, 210, interfacing a network 108, interfacing with a user through the user interface device 110, and the like. In a further embodiment, the server 102 may host an engine, application plug-in, or application programming interface (API).

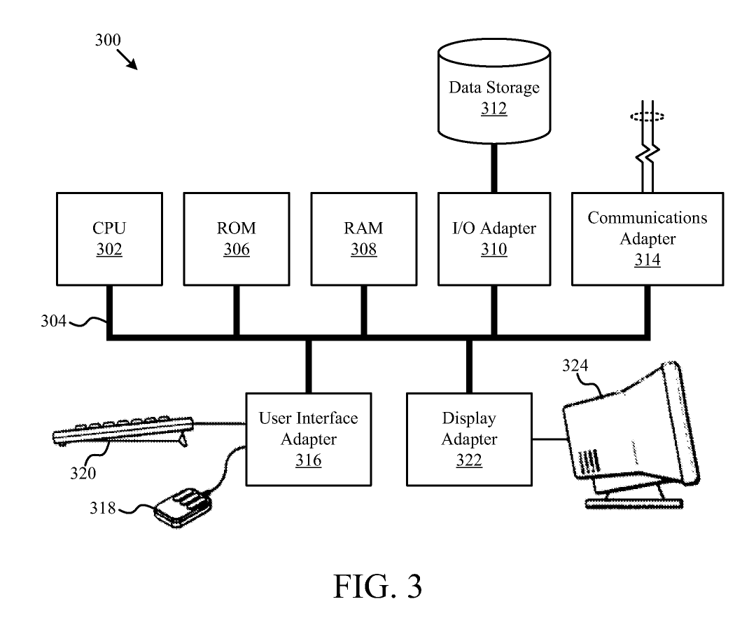

FIG. 3 illustrates a computer system 300 adapted according to certain embodiments of the server 102 and/or the user interface device 110. The central processing unit (“CPU”) 302 is coupled to the system bus 304. The CPU 302 may be a general purpose CPU or microprocessor, graphics processing unit (“GPU”), microcontroller, or the like. The present embodiments are not restricted by the architecture of the CPU 302 so long as the CPU 302, whether directly or indirectly, supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application such as business rules. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface associated with a software or web-based application. For example, the display adapter 322 may display menus allowing an administrator to input proposed camera locations on the server 102 through the user interface adapter 316.

The I/O adapter 310 may connect one or more storage devices 312, such as one or more of a hard drive, a compact disk (CD) drive, a floppy disk drive, and a tape drive, to the computer system 300. The communications adapter 314 may be adapted to couple the computer system 300 to the network 108, which may be one or more of a LAN, WAN, and/or the Internet. The user interface adapter 316 couples user input devices, such as a keyboard 320 and a pointing device 318, to the computer system 300. The display adapter 322 may be driven by the CPU 302 to control the display on the display device 324.

The applications of the present disclosure are not limited to the architecture of computer system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

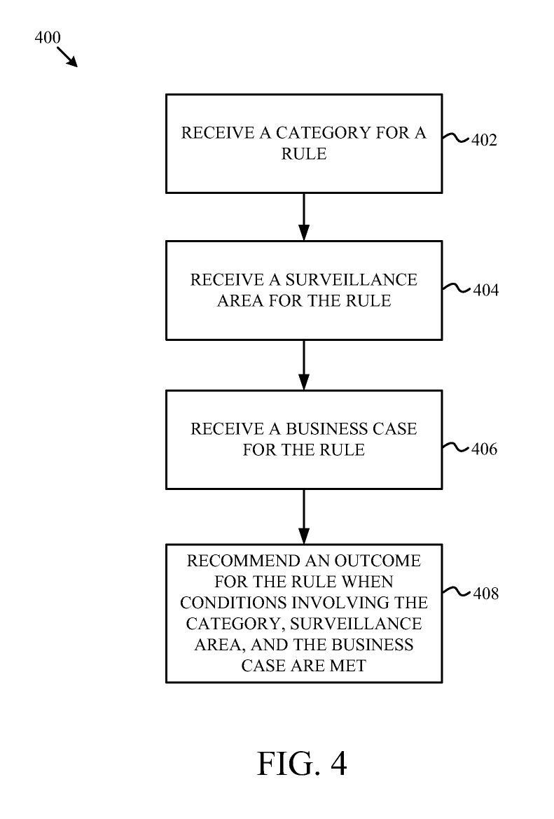

FIG. 4 is a flow chart illustrating a method of determining placement of a camera in a video surveillance system according to one embodiment of the disclosure. A method 400 begins at block 402 with receiving a category for a rule. The category may be, for example, whether the camera is an interior camera or an exterior camera. At block 404 a surveillance area for the rule is received. The surveillance area may be, for example, a terminal, a public road/parking, external entities, air operations area, access doors, public safety, passenger international entry zone, TSA screening area, TSA exit lane, ticketing, baggage area, gate area, hold area, vehicle traffic—public area, vehicle traffic—non-public area, critical asset, fixed vehicle checkpoint, parking lot, parking garage parking area, parking garage exit lane, terminal exterior, cargo area, leasehold area, commercial freight area, full length of runway, airport perimeter and camera redundancy. At block 406 a business case is received for the rule. According to one embodiment, the business cases are specific to surveillance areas. The tables below describe possible business cases for different surveillance areas.

TABLE 1
BUSINESS CASES FOR THE TERMINAL
SURVEILLANCE AREA.

| | |
|---|---|
| Passenger | area in which international passengers enter |
| International | the airport facility and United States |
| Entry Zone | territory for the first time from their |
| | foreign destination |
| Elevated Body | monitoring for passengers whose body |
| Temperature | temperatures indicate a high fever |
| Ticketing Area | where passengers check into airlines for |
| | their flight |
| Baggage | exit point for passengers to obtain baggage |
| Area | from their flights |
| Gate Area | where passengers await flight boarding |
| Hold Area | secure areas where passengers are segregated |
| | for investigative purposes |
| Critical Asset | assets of critical importance or high value |
| Screening Station | passenger examination area |
| Redundant Coverage | camera serves as a backup to a primary |
| on Primary Camera | camera |
| Failure | |

TABLE 2
BUSINESS CASES FOR THE PUBLIC ROADS/PARKING
SURVEILLANCE AREA.

| | |
|---|---|
| Vehicle | perimeter roads and public areas of vehicular |
| Traffic | traffic (for violations, against flow of traffic, |
| | accidents, unattended vehicles, congestion) |
| Vehicle | the floating police vehicle inspection areas |
| Checkpoint | |
| Parking Lot | parking lots for airport passengers and employees |
| | (for violations, accidents) |
| Parking | where parking lot users park their vehicles (for |
| Garage - | violations, against flow of traffic, accidents) |
| Parking | |
| Area | |
| Parking | where passengers pay the parking fee and exit the |
| Exit Lane | airport parking area (lot or garage) (for |
| | violations, against flow of traffic, accidents, |
| | congestion) |

TABLE 3
BUSINESS CASES FOR THE EXTERNAL
ENTITIES SURVEILLANCE AREA.

| | |
|---|---|
| TSA Screening | where the TSA screens passengers entering |
| Area | the sterile area of the airport from the |
| | public side |
| TSA Exit Lane | where passengers exit the sterile area and |
| | enter the public area |
| Airline/Commercial/ | real estate belonging to an external |
| CBP/TSA Property | agency/entity |
| Redundant Coverage | camera serves as a backup to a primary |
| on Primary Camera | camera |
| Failure | |

TABLE 4
BUSINESS CASES FOR THE AIR OPERATIONS
AREA SURVEILLANCE AREA.

| | |
|---|---|
| Vehicle Traffic | vehicles inside the secure, operational area |
| | of the airport |
| Critical Asset | assets of critical importance or high value |
| Cargo Area | cargo entering or exiting commercial |
| | passenger airplanes |
| Commercial Freight | cargo entering or exiting commercial |
| Area | freight airplanes |
| Leasehold Area | where airlines lease gate areas and park |
| | aircraft for passenger loading |
| Full Length of | entry and exit point for aircraft takeoff |
| Runway | and landing |
| Airplane Approach | airplanes preparing to land on an airport |
| | runway |
| Terminal Exterior | exterior portions of the airport physical |
| | structure |
| Airport perimeter | outer boundary of the airport |
| Redundant Coverage | camera serves as a backup to a primary |
| on Primary Camera | camera |
| Failure | |
| Maintain efficient | camera monitoring airfield area for orderly |
| Airport operations | movement of airplanes and service vehicles |

TABLE 5
BUSINESS CASES FOR THE ACCESS
DOORS SURVEILLANCE AREA.

| | |
|---|---|
| Redundant coverage | camera serves as a backup to a primary |
| on Primary Camera | camera |
| Failure | |
| Minimize disruption to | camera monitoring entry or exit through |
| Airport operations | access door connecting public and secure |
| | area for authorized and unauthorized |
| | movement |
| Minimize disruption to | camera monitoring entry or exit through |
| Airport operations | access door connecting public and secure |
| | area for authorized and unauthorized |
| | movement |
| Minimize disruption to | camera monitoring entry or exit through |
| Airport operations | access door connecting sterile and |
| | secure area for authorized and |
| | unauthorized movement |

TABLE 6
BUSINESS CASES FOR THE PUBLIC
SAFETY SURVEILLANCE AREA.

| | |
|---|---|
| Maintain efficient | camera monitoring area for crowd |
| Airport operations | congestion |
| Minimize disruption to | camera monitoring area for unusual |
| Airport operations | disturbance |
| Minimize disruption to | camera monitoring area for medical |
| Airport operations | emergency |
| Minimize disruption to | camera monitoring area for criminal |
| Airport operations | activity |
| Return Airport to | camera monitoring area for unusual crowd |
| normal state of | movement |
| operations | |
| Return Airport to | camera monitoring area for presence of |
| normal state of | unauthorized person |
| operations | |
| Return Airport to | camera monitoring area for presence of |
| normal state of | unauthorized vehicle |
| operations | |
| Minimize disruption to | camera provides two-way audio |
| Airport operations | communication between camera location |
| | and emergency operations center |
| Crisis management | camera facilitates aid and response of |
| | emergency personnel during an incident |

TABLE 7
BUSINESS CASES FOR THE PASSENGER INTERNATIONAL
ENTRY ZONE SURVEILLANCE AREA.

| | |
|---|---|
| Minimize disruption to | camera monitoring international arrivals |
| Airport operations | for elevated body temperature and |
| | potential presence of contagion |

TABLE 8
BUSINESS CASES FOR THE TSA SCREENING
AREA SURVEILLANCE AREA.

| | |
|---|---|
| Minimize disruption to | camera monitoring TSA screening area |
| Airport operations | for orderly movement |

TABLE 9
BUSINESS CASES FOR THE TSA EXIT
LANE SURVEILLANCE AREA.

| | |
|---|---|
| Minimize disruption to | camera monitoring TSA exit lanes for |
| Airport operations | orderly movement |

TABLE 10
BUSINESS CASES FOR THE TICKETING
SURVEILLANCE AREA.

| | |
|---|---|
| Maintain efficient | camera monitoring area for line congestion |
| Airport operations | |

TABLE 11
BUSINESS CASES FOR THE BAGGAGE
AREA SURVEILLANCE AREA.

| | |
|---|---|
| Maintain efficient | camera monitoring area for unclaimed baggage |
| Airport operations | |
| Maintain efficient | camera monitoring interstitial area for |
| Airport operations | normal operations |

TABLE 12
BUSINESS CASES FOR THE GATE
AREA SURVEILLANCE AREA.

| | |
|---|---|
| Minimize disruption to | camera monitoring gate area for normal |
| Airport operations | activity |

TABLE 13
BUSINESS CASES FOR THE HOLD
AREA SURVEILLANCE AREA.

| | |
|---|---|
| Minimize disruption to | camera monitoring hold area |
| Airport operations | for normal activity |

TABLE 14
BUSINESS CASES FOR THE VEHICLE TRAFFIC
PUBLIC AREA SURVEILLANCE AREA.

| | |
|---|---|
| Return Airport to | camera monitoring for unattended vehicle |
| normal state of | |
| operations | |
| Return Airport to | camera monitoring for vehicle accident |
| normal state of | |
| operations | |
| Maintain efficient | camera monitoring for traffic congestion |
| Airport operations | |
| Minimize disruption to | camera monitoring for vehicle traveling |
| Airport operations | against flow of traffic |
| Minimize disruption to | camera monitoring for vehicle committing |
| Airport operations | traffic violation |

TABLE 15
BUSINESS CASES FOR THE VEHICLE TRAFFIC
NON-PUBLIC AREA SURVEILLANCE AREA.

| | |
|---|---|
| Return Airport to | camera monitoring for unattended vehicle |
| normal state of | |
| operations | |
| Return Airport to | camera monitoring for vehicle accident |
| normal state of | |
| operations | |
| Maintain efficient | camera monitoring for traffic congestion |
| Airport operations | |
| Minimize disruption to | camera monitoring for vehicle traveling |
| Airport operations | against flow of traffic |
| Minimize disruption to | camera monitoring for vehicle committing |
| Airport operations | traffic violation |

TABLE 16
BUSINESS CASES FOR THE CRITICAL
ASSET SURVEILLANCE AREA.

| | |
|---|---|
| Minimize disruption to | camera monitoring |
| Airport operations | critical asset |

TABLE 17
BUSINESS CASES FOR THE FIXED VEHICLE CHECKPOINT.

| | |
|---|---|
| Minimize disruption to | camera monitoring police |
| Airport operations | vehicle check point. |

TABLE 18
BUSINESS CASES FOR THE PARKING
LOT SURVEILLANCE AREA.

| | |
|---|---|
| Minimize disruption to | camera monitoring parking lot for |
| Airport operations | orderly movement and parking |

TABLE 19
BUSINESS CASES FOR THE PARKING GARAGE
PARKING AREA SURVEILLANCE AREA.

| | |
|---|---|
| Minimize disruption to | camera monitoring parking garage for |
| Airport operations | orderly movement and parking |

TABLE 20
BUSINESS CASES FOR THE PARKING GARAGE
EXIT LANE SURVEILLANCE AREA.

| | |
|---|---|
| Minimize disruption to | camera monitoring vehicle exiting parking |
| Airport operations | lot for orderly movement. |

TABLE 21
BUSINESS CASES FOR THE TERMINAL
EXTERIOR SURVEILLANCE AREA.

| | |
|---|---|
| Minimize disruption to | camera monitoring terminal exterior |
| Airport operations | for events |

TABLE 22
BUSINESS CASES FOR THE CARGO
AREA SURVEILLANCE AREA.

| | |
|---|---|
| Minimize disruption to | camera monitoring cargo area for |
| Airport operations | orderly movement |

TABLE 23
BUSINESS CASES FOR THE LEASEHOLD
AREA SURVEILLANCE AREA.

| | |
|---|---|
| Maintain efficient | camera monitoring leasehold area |
| Airport operations | |

TABLE 24
BUSINESS CASES FOR THE COMMERCIAL
FREIGHT AREA SURVEILLANCE AREA.

| | |
|---|---|
| Minimize disruption to | camera monitoring commercial freight |
| Airport operations | area for orderly movement |

TABLE 25
BUSINESS CASES FOR THE FULL LENGTH
OF RUNWAY SURVEILLANCE AREA.

| | |
|---|---|
| Minimize disruption to | camera observing incoming and outgoing |
| Airport operations | airplanes for abnormal activity or |
| | condition |
| Maintain efficient | camera observing traffic conditions |
| Airport operations | on tarmac |

TABLE 26
BUSINESS CASES FOR THE AIRPORT
PERIMETER SURVEILLANCE AREA.

| | |
|---|---|
| Return Airport to | camera observing airport perimeter |
| normal state of | for unauthorized access |
| operations | |

TABLE 27
BUSINESS CASES FOR THE CAMERA
REDUNDANCY SURVEILLANCE AREA.

| | |
|---|---|
| Return Airport to | camera provides redundant coverage for |
| normal state of | out of service primary camera |
| operations | |

Referring back to FIG. 4, at block 408 an outcome is defined for the rule when conditions including the category, surveillance area, and the business case are met. For example, an outcome may be the placement or no placement of an additional security camera in a video surveillance system at the location defined by the category, surveillance area, and business case. According to one embodiment, the rule may be a logical rule such as an if-then statement. One example of a logical rule is: if (interior) and (access door) and (links public to sterile) then (install fixed camera on entry side and install fixed camera on exit side). In general, a logical rule may be constructed as: if (interior or exterior) and (operational area(s)) and (business case(s) applied) then (camera required). Additional examples of airport business rules include:

if (interior) and (terminal) and (monitors incoming passengers for elevated body temperature) then (install fixed camera to monitor for incoming passengers for elevated body temperature;

if (exterior) and (public roads and parking) and (monitors for traffic violation) then (install fixed/PTZ camera to monitor for traffic variation); and if (interior) and (external entities) and (monitors TSA screening area) then (install fixed camera to monitor persons in TSA screening area).

According to another embodiment, the rule may be a best practices rule. One example of a best practices rule is: In the terminal baggage claim area place: (two fixed IP cameras at each carousel X number of carousels)=total number of cameras.

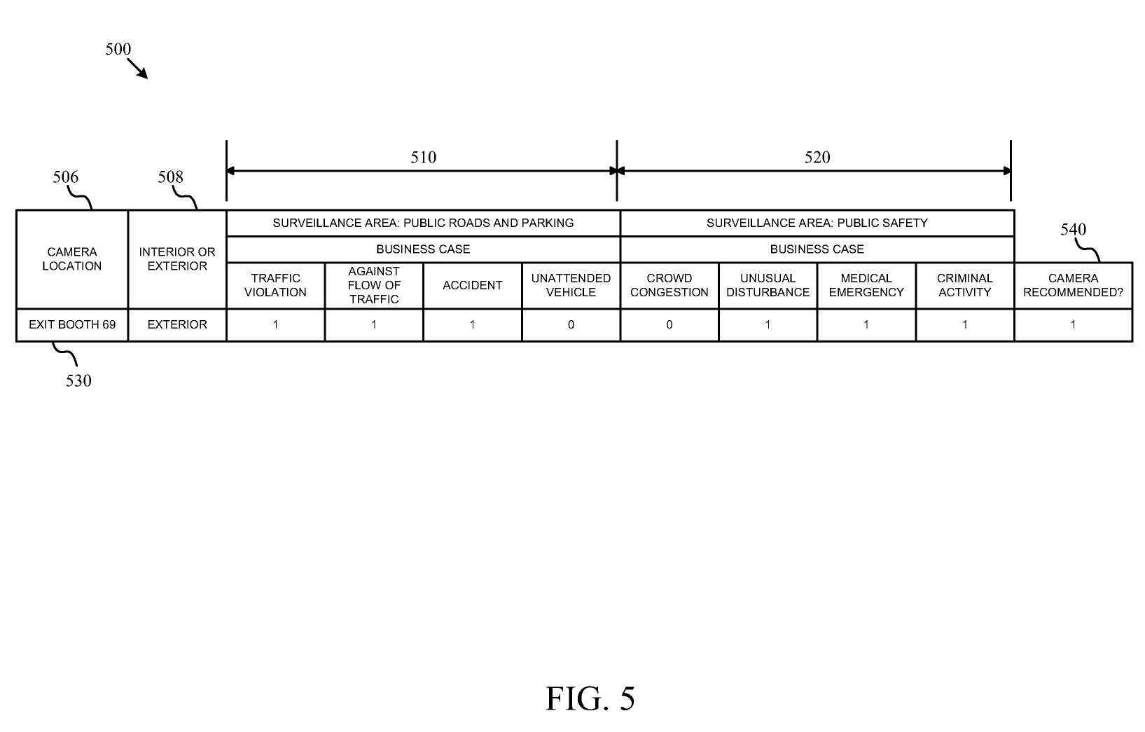

Business rules such as best practices rules and logical rules may be implemented in a spreadsheet with Boolean values. The spreadsheet may apply business cases against camera locations to identify recommendations for placement of additional cameras in a video surveillance system. An example of a spreadsheet for recommending additional security cameras is illustrated in FIG. 5. FIG. 5 is a example screen shot of a spreadsheet for recommending additional locations for security cameras according to one embodiment. A spreadsheet 500 includes a column 506 describing a proposed camera location and a column 508 describing a category for the proposed camera location. The spreadsheet 500 also includes columns 510 for business cases corresponding to a first surveillance area and columns 520 for business cases corresponding to a second surveillance area. Each proposed camera location occupies a row of the spreadsheet 500. For example, row 530 includes a proposed camera at exit booth 69. The columns 510 and 520 for the row 530 may be filled with Boolean values indicating whether a business case for a surveillance area is met by the proposed camera location. For example, a ‘1’ may indicate the business case is satisfied, and a ‘0’ may indicate the business case is not satisfied.

A recommendation column 540 displays whether a recommendation for a camera exists at the proposed location in each row of the spreadsheet 500. The column 540 of the row 530 may include a business rule for making the recommendation such as one of the if-then statements described above. According to one embodiment, the recommendation to install an additional security camera at the proposed location of each row of the spreadsheet 500 may be based, in part, on whether there is at least one identified business case within the surveillance area.

Proposing locations for additional security cameras in a video surveillance system and identifying business rules applicable to the proposed locations resolves the conflict between stakeholders in selecting locations for additional security cameras. That is, the business rule determines whether there is justification for placing an additional security camera at the proposed location. Although as discussed above each proposed camera location is tested against one business rule, there may be multiple business rules assigned to a proposed camera location.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a category for a rule;
receiving a surveillance area for the rule;
receiving a business case for the rule; and
recommending an outcome for the rule when conditions involving the category, the surveillance area, and the business case are met.

2. The method of claim 1, in which the recommending comprises recommending additional camera placement.

3. The method of claim 2, in which the additional camera placement is for an airport.

4. The method of claim 2, in which the recommending comprises calculating the result of a rule with a spreadsheet.

5. The method of claim 1, in which the rule is at least one of a logical rule and a best practices rule.

6. The method of claim 1, in which the category is at least one of interior and exterior.

7. The method of claim 1, in which the surveillance area is at least one of terminal, public roads/parking, external entities, air operations area, access doors, and public safety, passenger international entry zone, TSA screening area, TSA exit lane, ticketing, baggage area, gate area, hold area, vehicle traffic public area, vehicle traffic non-public area, critical asset, fixed vehicle checkpoint, parking lot, parking garage parking area, parking garage exit lane, terminal exterior, cargo area, leasehold area, commercial freight area, full length of runway, airport perimeter, and camera redundancy.

8. An apparatus, comprising:
at least one processor and a memory coupled to the at least one processor, in which the at least one processor is configured:
to receive a category for a rule;
to receive a surveillance area for the rule;
to receive a business case for the rule; and
to recommend an outcome for the rule when conditions involving the category, the surveillance area, and the business case are met.

9. The apparatus of claim 8, in which the at least one processor is further configured to recommend additional camera placement.

10. The apparatus of claim 9, in which the at least one processor is further configured to recommend additional camera placement for an airport.

11. The apparatus of claim 9, in which the at least one processor is further configured to calculate a recommendation from a spreadsheet.

12. The apparatus of claim 9, in which the rule is at least one of a logical rule and a best practices rule.

13. The apparatus of claim 9, in which the category is defined as at least one of interior and exterior.

14. A computer program product, comprising:
a computer-readable medium comprising:
code to receive a category for a rule;
code to receive a surveillance area for the rule;
code to receive a business case for the rule; and
code to recommend an outcome for the rule when conditions involving the category, the surveillance area, and the business case are met.

15. The computer program product of claim 14, in which the medium further comprises code to recommend additional camera placement.

16. The computer program product of claim 15, in which the medium further comprises code to recommend an additional camera in an airport.

17. The computer program product of claim 15, in which the medium further comprises code to calculate a recommendation from a spreadsheet.

18. The computer program product of claim 15, in which the medium further comprises code to define at least one of a logical rule and a best practices rule.

19. The computer program product of claim 15, in which the category comprises at least one of interior and exterior.

20. The computer program product of claim 15, in which the surveillance area is at least one of terminal, public roads/parking, external entities, air operations area, access doors, and public safety, passenger international entry zone, TSA screening area, TSA exit lane, ticketing, baggage area, gate area, hold area, vehicle traffic public area, vehicle traffic non-public area, critical asset, fixed vehicle checkpoint, parking lot, parking garage parking area, parking garage exit lane, terminal exterior, cargo area, leasehold area, commercial freight area, full length of runway, airport perimeter, and camera redundancy.
